(19) United States
(12) Patent Application Publication
(10) Pub. No.: US 2026/0368311 A1
(43) Pub. Date: Nov. 19, 2026

(54) SYSTEMS AND METHODS OF FACILITATING A SECURITY MONITORING

(71) Applicant: Geogentia Inc., Holland, MI (US)

(72) Inventors: Brandon Gregg, Santa Cruz, CA (US); Vijay Richard, Wesley Chapel, FL (US)

(73) Assignee: Geogentia Inc., Holland, MI (US)

(21) Appl. No.: 19/209,050

(22) Filed: May 15, 2025

(51) Int. Cl. G06F 21/55

(52) U.S. Cl. CPC G06F 21/552; G06F 21/554; G06F 2221/034

(57) ABSTRACT

The present disclosure provides a method of facilitating a security monitoring. Further, the method may include receiving two or more location data from a client device. Further, the two or more location data corresponds to two or more locations of one or more entities. Further, the method may include pre-processing the two or more location data to obtain two or more pre-processed location data. Further, the pre-processing reduces noise associated with the two or more location data. Further, the method may include analyzing the two or more pre-processed location data based on a security criterion. Further, the method may include determining a security event based on the analyzing. Further, the method may include generating an event data based on the determining. Further, the event data represents the security event. Further, the method may include transmitting the event data to a user device associated with a user.

### FIELD OF DISCLOSURE

The present disclosure generally relates to a field of data processing. More specifically, the present disclosure related to systems and methods of facilitating a security monitoring.

### BACKGROUND

Perimeter security monitoring is a critical aspect of modern security infrastructure, particularly in the protection of secured perimeters, such as border walls, property lines, and restricted areas, and is critical for security, safety, and regulatory compliance. The ability to detect unauthorized breaches in perimeter defenses is essential for maintaining the integrity and safety of these facilities. As cyber-physical threats continue to evolve, so too do the methods used to breach protected areas, making it increasingly challenging to maintain robust security measures.

Traditional perimeter security systems often rely on fixed physical barriers or static monitoring solutions, which may become inadequate in dynamic environments where natural changes (e.g., weather conditions) and human-induced modifications (e.g., construction activities) occur frequently. Further, existing security measures, such as physical barriers, surveillance cameras, and sensor-based detection systems, are susceptible to evasion techniques such as tunneling, climbing, or forceful breach attempts. Additionally, these systems may struggle to adapt to complex breach patterns that involve sophisticated movements, such as those involving multiple devices working in concert to bypass security measures.

The evolution of mobile technologies has introduced new challenges, as mobile devices equipped with global positioning system (GPS) and other location-tracking capabilities generate vast amounts of data. Further, mobile device location data has the potential to provide valuable intelligence regarding movement patterns near secure perimeters. However, existing systems may not adequately process this information to identify subtle yet critical breaches in perimeter defenses due to the complexities of radio frequency (RF) signal propagation, location triangulation errors, and the high density of mobile signals in busy areas. Furthermore, environmental noise, sensor inaccuracies, and background movements may lead to false positives or missed detections, reducing the reliability of security monitoring.

Moreover, as the number of connected devices and integration of connected devices into security systems increases, the potential for coordinated breaches has grown. Traditional methods may lack the capability to analyze multi-device movements in real-time, making it difficult to detect complex patterns indicative of unauthorized access attempts.

Therefore, there is a need for improved systems and methods of facilitating a security monitoring, that can overcome one or more of the preceding problems.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter’s scope.

The present disclosure provides a method of facilitating a security monitoring. Further, the method may include receiving, using a communication device, two or more location data from a client device. Further, the two or more location data corresponds to two or more locations of one or more entities. Further, the method may include pre-processing, using a processing device, the two or more location data to obtain two or more pre-processed location data. Further, the pre-processing reduces noise associated with the two or more location data. Further, the method may include analyzing, using the processing device, the two or more pre-processed location data based on a security criterion. Further, the method may include determining, using the processing device, a security event based on the analyzing. Further, the method may include generating, using the processing device, an event data based on the determining. Further, the event data represents the security event. Further, the method may include transmitting, using the communication device, the event data to a user device associated with a user.

The present disclosure provides a system for facilitating a security monitoring. Further, the system may include a communication device. Further, the communication device may be configured for receiving two or more location data from a client device. Further, the two or more location data corresponds to two or more locations of one or more entities. Further, the communication device may be configured for transmitting an event data to a user device associated with a user. Further, the system may include a processing device communicatively coupled with the communication device. Further, the processing device may be configured for pre-processing the two or more location data to obtain two or more pre-processed location data. Further, the pre-processing reduces noise associated with the two or more location data. Further, the processing device may be configured for analyzing the two or more pre-processed location data based on a security criterion. Further, the processing device may be configured for determining a security event based on the analyzing. Further, the processing device may be configured for generating the event data based on the determining. Further, the event data represents the security event.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 illustrates a flowchart of a method 300 of facilitating a security monitoring, in accordance with some embodiments.

FIG. 4 illustrates a flowchart of a method 400 of facilitating a security monitoring including filtering the erratic location data, in accordance with some embodiments.

FIG. 5 illustrates a flowchart of a method 500 of facilitating a security monitoring including pre-processing further comprises filtering the outlier data from the plurality of location data, in accordance with some embodiments.

FIG. 6 illustrates a flowchart of a method 600 of facilitating a security monitoring including generating, using the processing device 704, a representation data, in accordance with some embodiments.

FIG. 7 illustrates a block diagram of a system 700 of facilitating a security monitoring, in accordance with some embodiments.

FIG. 8 illustrates the block diagram of the system 700 of facilitating a security monitoring associated with each of a client device 802 and a user device 804, in accordance with some embodiments.

FIG. 9 illustrates a flowchart of a method 900 of facilitating a security monitoring including generating, using the processing device 704, an alert data, in accordance with some embodiments.

FIG. 10 illustrates a flowchart of a method 1000 of facilitating a security monitoring including generating, using the processing device 704, a report data, in accordance with some embodiments.

FIG. 11 illustrates two or more locations 1102 of one or more entities within a monitored area 1100, in accordance with some embodiments.

FIG. 12 illustrates a security event 1202 associated with the monitored area 1100, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes Pathfinder. Further, the present disclosure describes method and system for identifying potential breaches of secured perimeters. Further, the method and system uses mobile device location data and artificial intelligence algorithms to analyze movement patterns. Further, the present disclosure relates to the field of security monitoring and detection.

Further, the present disclosure describes an advanced AI-driven approach to process and filter mobile device location data, effectively distinguishing between normal background noise and devices exhibiting movement patterns indicative of a potential perimeter breach.

Further, the method detects unauthorized crossings of secured perimeters by analyzing mobile device data collected from both sides of a given boundary. Further, the method systematically examines device movement patterns, including changes in latitude, longitude, timestamps, directionality, and spacing between points.

A proprietary AI-driven algorithm processes this data to identify instances where a mobile device appears to transition across a secure perimeter in a manner consistent with climbing over, tunneling under, or forcefully breaching the barrier. By filtering out static or irrelevant movement, the system highlights devices and locations where breaches are likely occurring.

In addition to traditional AI-driven analysis, the method and system includes several technological improvements to enhance detection accuracy and reduce false positives:
1. A multi-layer data preprocessing architecture, combining Kalman filtering, outlier detection, and time-series interpolation to improve the quality of mobile location data.
2. A Spatial-Temporal Vector Analysis Engine, capable of constructing and analyzing movement vectors to detect complex movement patterns indicative of perimeter breaches.
3. A Dynamic Perimeter Mapping Component that ingests updated geospatial data and dynamically adjusts the monitored boundary in real time, ensuring ongoing system accuracy.

These improvements significantly enhance security monitoring capabilities while reducing false positives and system latency.

Further, the method and system follows the following process:
1. Data Collection
   Mobile device location data is gathered over a specified period from sources such as cellular network providers, Wi-Fi signals, and GPS-based data sources. The data includes timestamped latitude and longitude coordinates of mobile devices near the secured perimeter.
2. Advanced Data Preprocessing
   The collected data undergoes a multi-layer preprocessing pipeline specifically designed to address noise and inaccuracies inherent in mobile tracking technologies.
   Kalman Filters are applied to smooth out erratic location readings by predicting a device’s next position based on prior movement, reducing sudden, inaccurate jumps in location.
   Outlier Detection Algorithms, such as Density-Based Spatial Clustering of Applications with Noise (DBSCAN), are employed to identify and remove anomalous data points that may result from signal drift or reflection artifacts.
   Time-Series Interpolation and Gap Filling techniques ensure continuity in device tracking by estimating missing data points, maintaining a consistent record of movement. This preprocessing pipeline increases data reliability, ensuring the subsequent analysis is based on clean and normalized information.
3. Perimeter Definition and Dynamic Adjustment
   A digital representation of the secure perimeter is established within the system, defining the boundary to be monitored.
   The Dynamic Perimeter Mapping Component is capable of ingesting updated GIS data, drone imagery, or sensor inputs, enabling real-time recalibration of the perimeter boundary.
   Any detected shifts or changes in the physical boundary—such as construction activities or natural environmental changes—are automatically incorporated into the system’s perimeter model.
   This ensures the boundary being monitored accurately reflects real-world conditions, minimizing false alerts caused by outdated or incorrect perimeter data.
4. Movement Analysis with Spatial-Temporal Vector Analysis Engine
   The system systematically examines individual device movements over time using a Spatial-Temporal Vector Analysis Engine.
   Movement Vectors are constructed from sequential location points of each device, representing the direction, distance, and speed of movement across time intervals.
   The system assesses vector magnitude and directional consistency, identifying patterns consistent with climbing over, tunneling under, or rapidly breaching the perimeter.
   The engine applies context-aware rules, such as detecting abrupt directional changes, loitering behavior near boundary edges, and movement velocities inconsistent with typical pedestrian or vehicle activity.
5. Filtering and Classification
   After preprocessing and vector analysis, the AI-driven classification model isolates devices exhibiting movement patterns consistent with a perimeter breach.
   Background noise from stationary devices or unrelated movement is filtered out, allowing security personnel to focus on probable breach events.
6. Alerting and Visualization
   Identified breach events are displayed on an interactive interface, highlighting locations of concern along the perimeter. Alerts may be generated in real-time to notify security teams, and reports may be archived for forensic review.

Following are key aspects of the methods and systems:
1. A method for detecting perimeter breaches using mobile device data, comprising:
   Collecting mobile device location data from both sides of a secure perimeter over a predefined period;
   Preprocessing the collected data using Kalman filtering, outlier detection, and time-series interpolation to reduce noise and improve data quality;
   Analyzing movement patterns using an artificial intelligence algorithm, wherein a Spatial-Temporal Vector Analysis Engine constructs movement vectors and assesses directional and speed-related data;
   Identifying devices that exhibit movement consistent with crossing the perimeter, based on vector magnitude and directional changes;
   Dynamically adjusting the digital representation of the secure perimeter by ingesting updated geospatial data;
   Generating alerts and visualizations highlighting potential security breaches.
2. A system for detecting unauthorized crossings of secured perimeters, comprising:
   A data collection module configured to aggregate mobile device location data from multiple sources;
   A preprocessing engine to normalize and clean location data, employing Kalman filters, outlier detection algorithms, and time-series interpolation techniques;
   A Spatial-Temporal Vector Analysis Engine configured to construct and analyze movement vectors based on the cleaned data;
   A dynamic perimeter mapping component that updates the secure boundary based on real-time geospatial inputs;
   An AI-driven analytics module to assess movement patterns and classify perimeter-crossing behaviors;
   A reporting interface that provides real-time alerts and visual representations of detected breaches.
3. Further, the dynamic perimeter mapping component ingests updated GIS data, drone imagery, or external sensor data to recalibrate the digital perimeter representation in real time.
4. Further, the Spatial-Temporal Vector Analysis Engine applies context-aware rules to detect abrupt directional changes, loitering near boundaries, and abnormal movement velocities indicative of a potential perimeter breach.

Further, the system may integrate machine learning models to enhance anomaly detection capabilities. This approach may identify sophisticated breach patterns that traditional methods might miss.

Further, the system may leverage the high-speed processing capabilities of 5G or LTE-M networks for real-time data analysis. This ensures that location data is processed quickly and accurately.

Further, the system may incorporate privacy-preserving techniques like differential privacy to protect user location data. This ensures that sensitive information is not exposed unnecessarily.

Further, the system may fuse location data from multiple sensors or devices to improve accuracy. This may include combining GPS data with data from Wi-Fi signals or cell tower locations.

Further, the system may perform behavioral analysis to identify normal movement patterns. This allows the system to distinguish between normal activity and suspicious movements indicative of breaches.

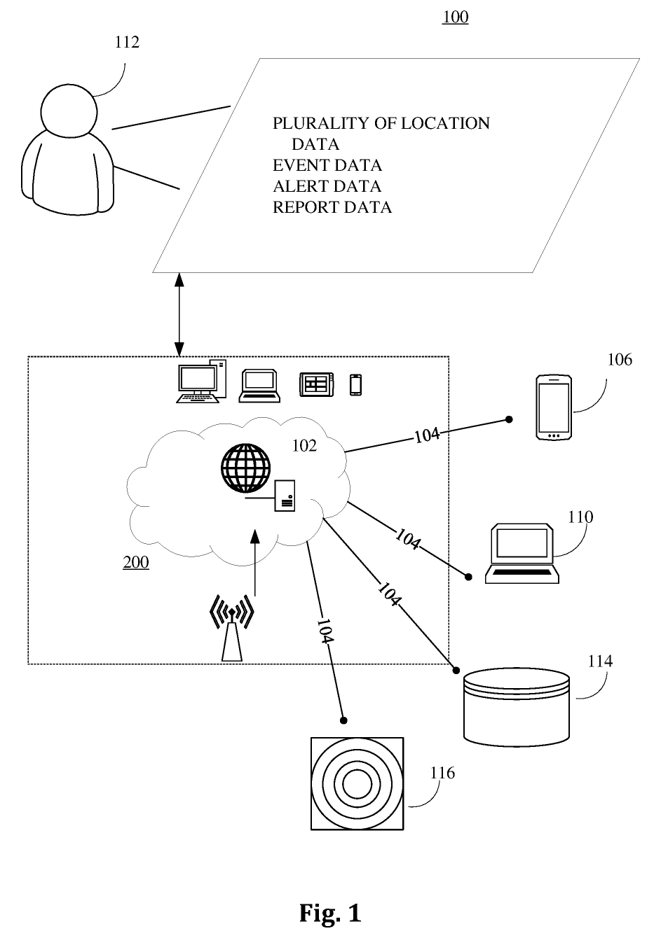

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

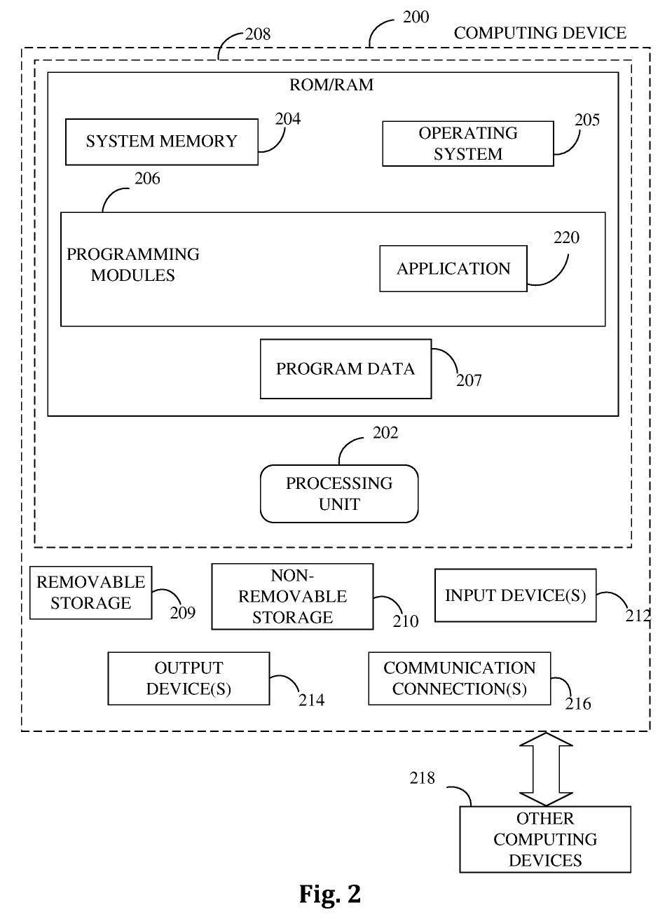

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200’s operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods’ stages may be modified in any manner, including by reordering stages and/or inserting or deleting stages, without departing from the disclosure.

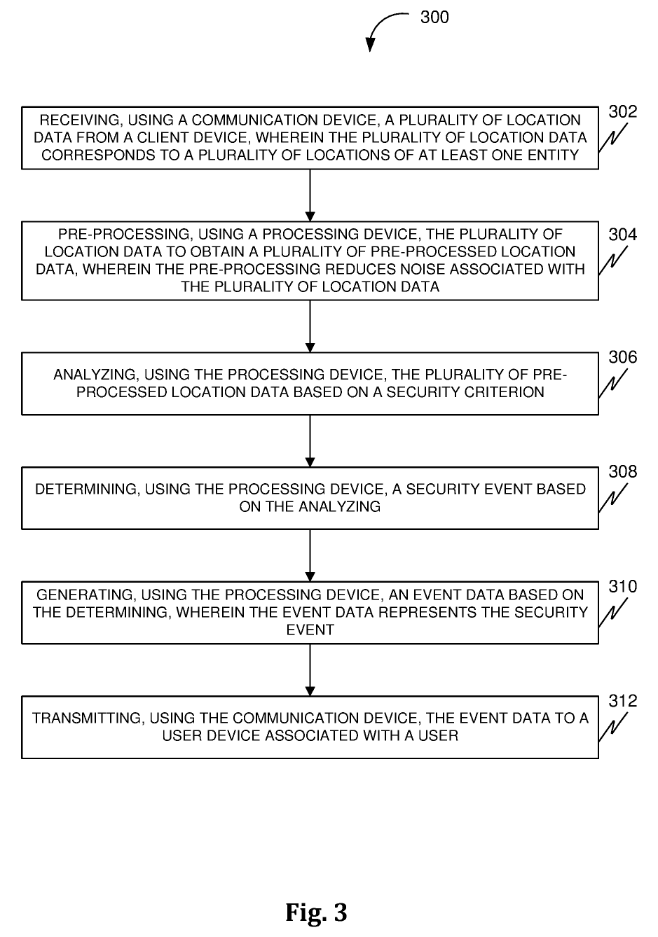

FIG. 3 illustrates a flowchart of a method 300 of facilitating a security monitoring, in accordance with some embodiments.

Accordingly, the method 300 may include a step 302 of receiving, using a communication device 702, two or more location data from a client device 802. Further, the two or more location data corresponds to two or more locations of one or more entities. Further, the method 300 may include a step 304 of pre-processing, using a processing device 704, the two or more location data to obtain two or more pre-processed location data. Further, the pre-processing reduces noise associated with the two or more location data. Further, the method 300 may include a step 306 of analyzing, using the processing device 704, the two or more pre-processed location data based on a security criterion. Further, the method 300 may include a step 308 of determining, using the processing device 704, a security event based on the analyzing. Further, the method 300 may include a step 310 of generating, using the processing device 704, an event data based on the determining. Further, the event data represents the security event. Further, the method 300 may include a step 312 of transmitting, using the communication device 702, the event data to a user device 804 associated with a user.

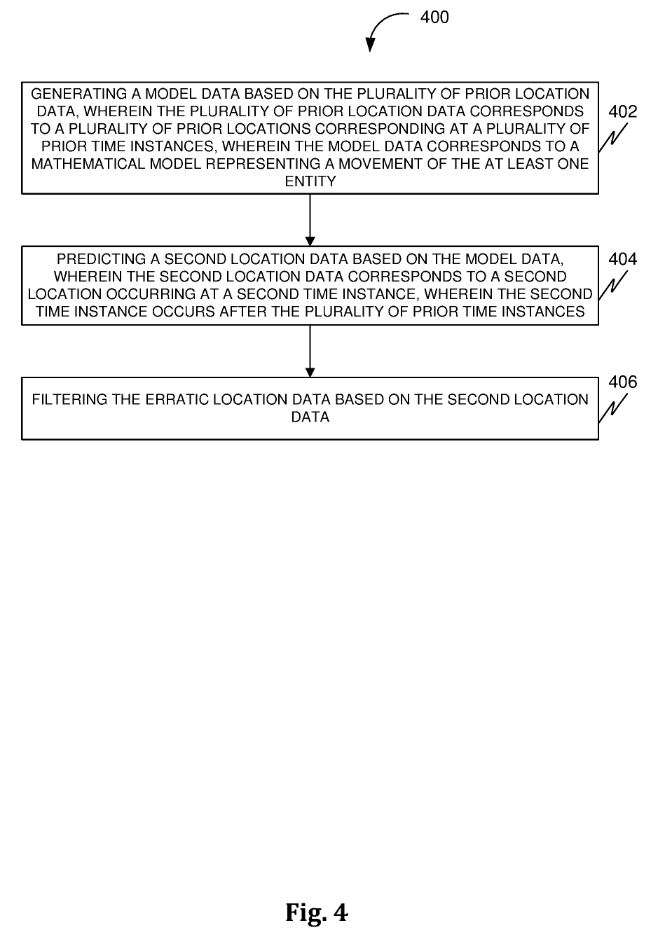

FIG. 4 illustrates a flowchart of a method 400 of facilitating a security monitoring including filtering the erratic location data, in accordance with some embodiments.

Further, in some embodiments, the two or more location data may include each of two or more prior location data and an erratic location data representing a random change in one or more of the two or more locations. Further, the pre-processing may include a step 402 of generating a model data based on the two or more prior location data. Further, the two or more prior location data corresponds to two or more prior locations corresponding at two or more prior time instances. Further, the model data corresponds to a mathematical model representing a movement of the one or more entities. Further, the pre-processing may include a step 404 of predicting a second location data based on the model data. Further, the second location data corresponds to a second location occurring at a second time instance. Further, the second time instance occurs after the two or more prior time instances. Further, the pre-processing may include a step 406 of filtering the erratic location data based on the second location data.

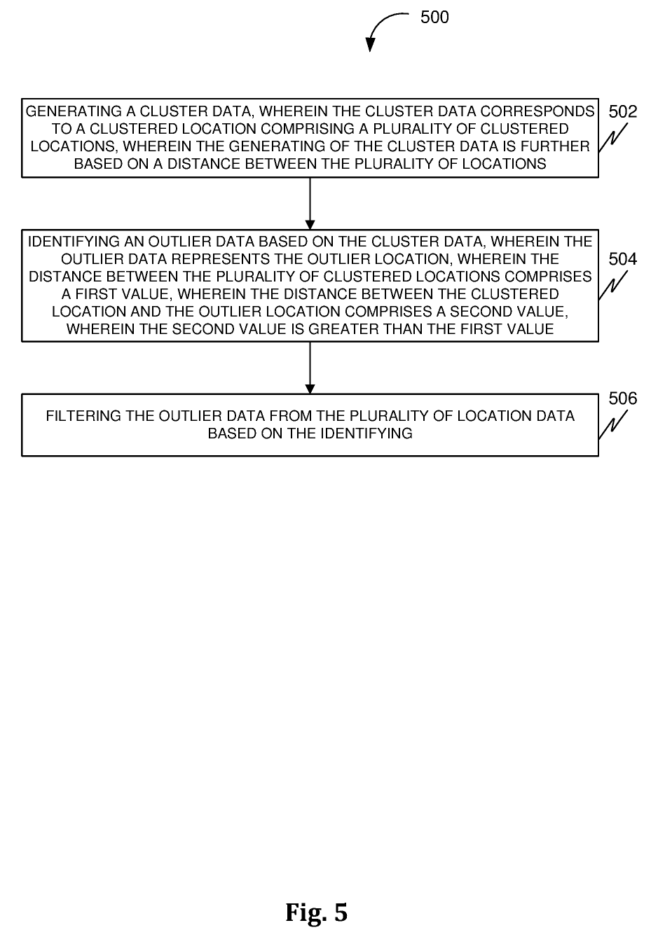

FIG. 5 illustrates a flowchart of a method 500 of facilitating a security monitoring including pre-processing further comprises filtering the outlier data from the plurality of location data, in accordance with some embodiments.

Further, in some embodiments, the noise corresponds to an outlier location. Further, the two or more locations may include an outlier location. Further, the pre-processing may include a step 502 of generating a cluster data. Further, the cluster data corresponds to a clustered location comprising two or more clustered locations. Further, the generating of the cluster data may be further based on a distance between the two or more locations. Further, the noise corresponds to an outlier location. Further, the pre-processing may include a step 504 of identifying an outlier data based on the cluster data. Further, the outlier data represents the outlier location. Further, the distance between the two or more clustered locations include a first value. Further, the distance between the clustered location and the outlier location includes a second value. Further, the second value may be greater than the first value. Further, the noise corresponds to an outlier location. Further, the pre-processing may include a step 506 of filtering the outlier data from the two or more location data based on the identifying.

In some embodiments, the pre-processing includes predicting a missed location data based on the two or more location data. Further, the missed location data corresponds to a missed location. Further, the predicting of the missed location data may be based on an interpolating of two or more adjacent locations. Further, the two or more adjacent locations may be adjacent to the missed location. Further, the interpolating may be based on an interpolation technique based on two or more time instances. Further, the two or more locations occur at the two or more time instances. Further, the two or more location data represent the two or more locations with the two or more time instances. Further, the two or more locations include the two or more adjacent locations.

In some embodiments, the pre-processing includes predicting a missed location data based on the two or more location data. Further, the missed location data corresponds to a missed location. Further, the predicting of the missed location data may be further based on two or more factors associated with the two or more locations. Further, the two or more factors correspond to a pattern and a context associated with the two or more locations.

In some embodiments, the determining of the security event includes identifying a movement pattern of the one or more entities. Further, the movement pattern may be associated with a movement characteristic. Further, one or more of the movement pattern and the movement characteristic indicates the security event.

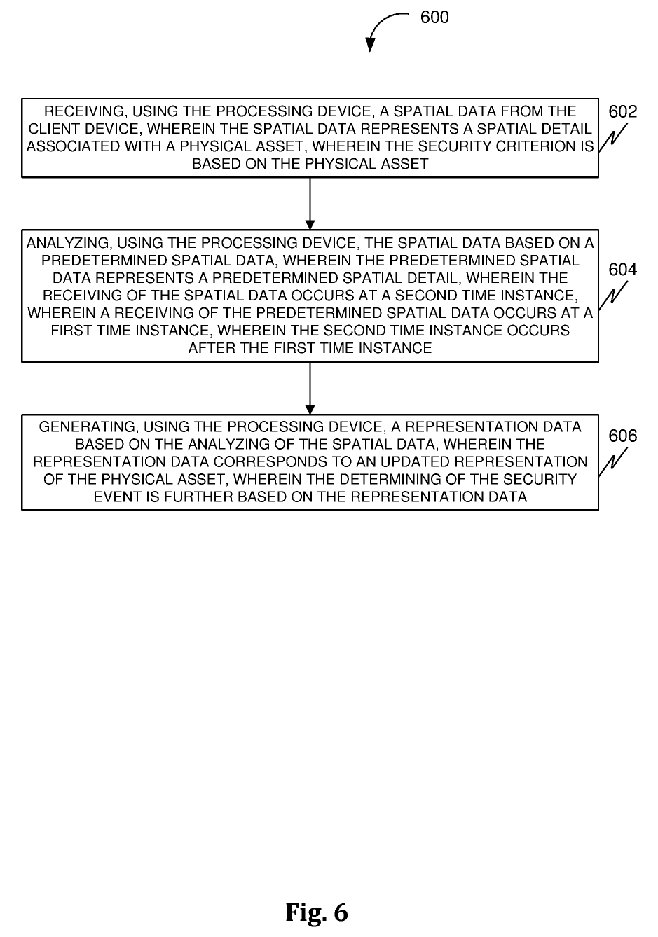

FIG. 6 illustrates a flowchart of a method 600 of facilitating a security monitoring including generating, using the processing device 704, a representation data, in accordance with some embodiments.

Further, in some embodiments, the method 600 further may include a step 602 of receiving, using the processing device 704, a spatial data from the client device 802. Further, the spatial data represents a spatial detail associated with a physical asset. Further, the security criterion may be based on the physical asset. Further, in some embodiments, the method 600 further may include a step 604 of analyzing, using the processing device 704, the spatial data based on a predetermined spatial data. Further, the predetermined spatial data represents a predetermined spatial detail. Further, the receiving of the spatial data occurs at a second time instance. Further, a receiving of the predetermined spatial data occurs at a first time instance. Further, the second time instance occurs after the first time instance. Further, in some embodiments, the method 600 further may include a step 606 of generating, using the processing device 704, a representation data based on the analyzing of the spatial data. Further, the representation data corresponds to an updated representation of the physical asset. Further, the determining of the security event may be further based on the representation data.

In some embodiments, the method 300 may further include generating, using the processing device 704, a vector data based on the analyzing of the two or more pre-processed location data. Further, the vector data represents a movement associated with the one or more entities based on two or more characteristics. Further, the two or more characteristics correspond to each of a magnitude and a direction of the movement. Further, the determining of the security event may be further based on the vector data.

In some embodiments, the determining of the security event includes differentiating an event movement from a normal movement based on the two or more characteristics. Further, the event movement corresponds to an activity associated with the security event. Further, the vector data represents two or more movements comprising each of the event movement and the normal movement. Further, the two or more locations correspond to the two or more movements.

In some embodiments, the security criterion may be based on a secured perimeter. Further, the security event corresponds to an unauthorized breach of a secured perimeter.

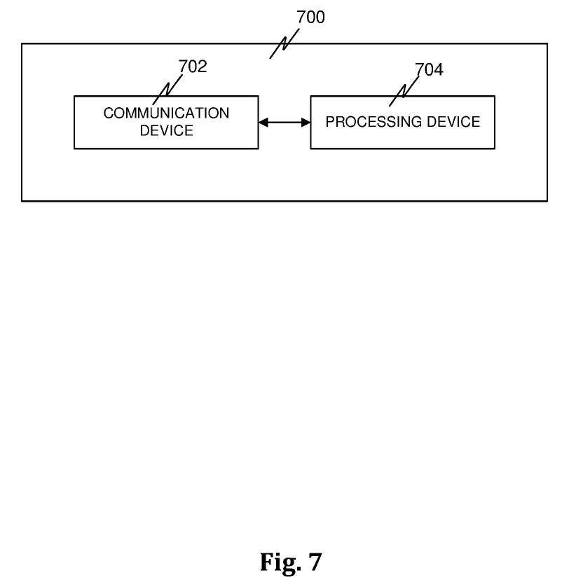

FIG. 7 illustrates a block diagram of a system 700 of facilitating a security monitoring, in accordance with some embodiments.

Accordingly, the system 700 may include a communication device 702. Further, the communication device 702 may be configured for receiving two or more location data from a client device 802. Further, the two or more location data corresponds to two or more locations of one or more entities. Further, the communication device 702 may be configured for transmitting an event data to a user device 804 associated with a user. Further, the system 700 may include a processing device 704 communicatively coupled with the communication device 702. Further, the processing device 704 may be configured for pre-processing the two or more location data to obtain two or more pre-processed location data. Further, the pre-processing reduces noise associated with the two or more location data. Further, the processing device 704 may be configured for analyzing the two or more pre-processed location data based on a security criterion. Further, the processing device 704 may be configured for determining a security event based on the analyzing. Further, the processing device 704 may be configured for generating the event data based on the determining. Further, the event data represents the security event.

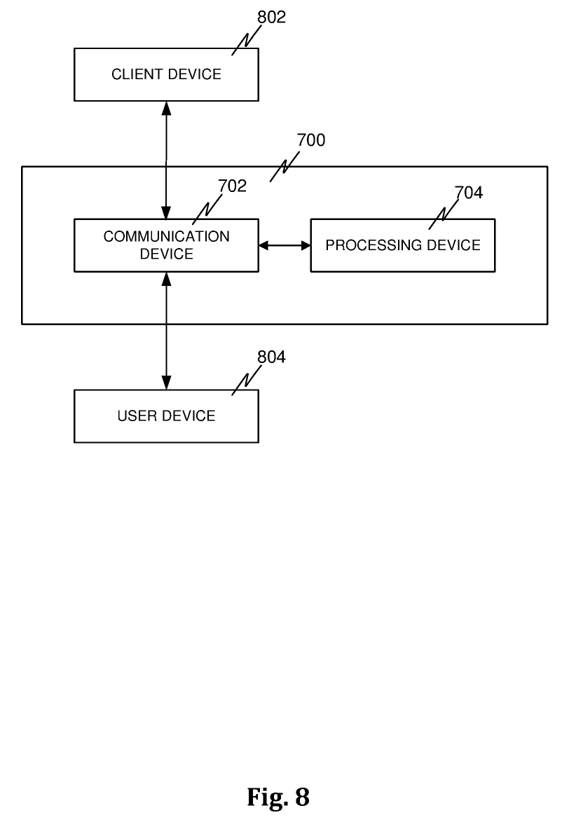

FIG. 8 illustrates the block diagram of the system 700 of facilitating a security monitoring associated with each of the client device 802 and the user device 804, in accordance with some embodiments.

Further, in some embodiments, the two or more location data may include each of two or more prior location data and an erratic location data representing a random change in one or more of the two or more locations. Further, the pre-processing may include generating a model data based on the two or more prior location data. Further, the two or more prior location data corresponds to two or more prior locations corresponding at two or more prior time instances. Further, the model data corresponds to a mathematical model representing a movement of the one or more entities. Further, the pre-processing may include predicting a second location data based on the model data. Further, the second location data corresponds to a second location occurring at a second time instance. Further, the second time instance occurs after the two or more prior time instances. Further, the pre-processing may include filtering the erratic location data based on the second location data.

Further, in some embodiments, the noise corresponds to an outlier location. Further, the two or more locations may include an outlier location. Further, the pre-processing may include generating a cluster data. Further, the cluster data corresponds to a clustered location comprising two or more clustered locations. Further, the generating of the cluster data may be further based on a distance between the two or more locations. Further, the noise corresponds to an outlier location. Further, the pre-processing may include identifying an outlier data based on the cluster data. Further, the outlier data represents the outlier location. Further, the distance between the two or more clustered locations include a first value. Further, the distance between the clustered location and the outlier location includes a second value. Further, the second value may be greater than the first value. Further, the noise corresponds to an outlier location. Further, the pre-processing may include filtering the outlier data from the two or more location data based on the identifying.

In some embodiments, the pre-processing includes predicting a missed location data based on the two or more location data. Further, the missed location data corresponds to a missed location. Further, the predicting of the missed location data may be based on an interpolating of two or more adjacent locations. Further, the two or more adjacent locations may be adjacent to the missed location. Further, the interpolating may be based on an interpolation technique based on two or more time instances. Further, the two or more locations occur at the two or more time instances. Further, the two or more location data represents the two or more locations with the two or more time instances. Further, the two or more locations include the two or more adjacent locations.

In some embodiments, the pre-processing includes predicting a missed location data based on the two or more location data. Further, the missed location data corresponds to a missed location. Further, the predicting of the missed location data may be further based on two or more factors associated with the two or more locations. Further, the two or more factors corresponds to a pattern and a context associated with the two or more locations.

In some embodiments, the determining of the security event includes identifying a movement pattern of the one or more entities. Further, the movement pattern may be associated with a movement characteristic. Further, one or more of the movement pattern and the movement characteristic indicates the security event.

Further, in some embodiments, the processing device 704 may be further configured for receiving a spatial data from the client device 802. Further, the spatial data represents a spatial detail associated with a physical asset. Further, the security criterion may be based on the physical asset. Further, the processing device 704 may be further configured for analyzing the spatial data based on a predetermined spatial data. Further, the predetermined spatial data represents a predetermined spatial detail. Further, the receiving of the spatial data occurs at a second time instance. Further, a receiving of the predetermined spatial data occurs at a first time instance. Further, the second time instance occurs after the first time instance. Further, the processing device 704 may be further configured for generating a representation data based on the analyzing of the spatial data. Further, the representation data corresponds to an updated representation of the physical asset. Further, the determining of the security event may be further based on the representation data.

In some embodiments, the processing device 704 may be further configured for generating a vector data based on the analyzing. Further, the vector data represents a movement associated with the one or more entities based on two or more characteristics. Further, the two or more characteristics correspond to each of a magnitude and a direction of the movement. Further, the determining of the security event may be further based on the vector data.

In some embodiments, the determining of the security event includes differentiating an event movement from a normal movement based on the two or more characteristics. Further, the event movement corresponds to an activity associated with the security event. Further, the vector data represents two or more movements comprising each of the event movement and the normal movement. Further, the two or more locations correspond to the two or more movements.

In some embodiments, the determining of the security event may be based on a AI model. Further, the AI model comprises a ML model.

In some embodiments, the AI model may be trained on a location dataset. Further, the location dataset includes two or more mobile device location data. Further, the AI model may be configured to learn a pattern from the two or more mobile device location data. Further, the pattern indicates the security event.

In some embodiments, the security event includes a secured perimeter breach.

In some embodiments, the generating of the vector data may be based on the AI model. Further, the AI model may be trained to construct a vector indicating the movement associated with the one or more entities. Further, the AI model may determine the security event based on one or more of the magnitude and the direction associated with the movement.

In some embodiments, the AI model may be trained to determine the security event based on a speed of the movement. Further, the magnitude corresponds to the speed.

In some embodiments, the pre-processing of the two or more location data is based on the AI model. Further, the AI model may be based on the noise filtering algorithm.

In some embodiments, the AI model may be trained on a simulated location data. Further, the simulated location data may correspond to a simulated location simulating a real-word location. Further, the real-world location includes the two or more locations of one or more entity. Further, the simulated location may be associated with a characteristic corresponding to the two or more locations.

In some embodiments, the characteristic may correspond to one or more of a movement pattern and a noise.

In some embodiments, the noise filtering algorithm include one or more of a Kalman filtering algorithm and an outlier detection algorithm.

In some embodiments, the AI mode may be trained to filter one or more of an erratic location and an anomalous location.

In some embodiments, the AI model is based one or more of a deep learning algorithm and a machine learning technique. Further, the deep learning algorithm corresponds to one or more of a recurrent neural network and a convolution neural network. Further, the machine learning technique includes one or more of k-nearest neighbors, k means clustering, and principal component analysis.

In some embodiments, the security criterion may be based on a secured perimeter. Further, the security event corresponds to an unauthorized breach of a secured perimeter.

In some embodiments, the one or more entities represents one or more of a person, an animal, and an asset.

In some embodiments, the outlier location may be based on a signal distortion.

In some embodiments, the pre-processing reduces a false location. Further, the two or more locations include the false location.

In some embodiments, the filtering of the erratic location data may be based on a noise filtering algorithm.

In some embodiments, the noise filtering algorithm corresponds to a Kalman filter.

In some embodiments, the filtering of the outlier data may be based on an outlier detection algorithm.

In some embodiments, the outlier detection algorithm includes a clustering algorithm.

In some embodiments, the clustering algorithm corresponds to a Density-Based Spatial Clustering of Applications with Noise.

In some embodiments, the signal distortion corresponds to one or more of a signal drift and a signal reflection artifact.

In some embodiments, the interpolation technique includes a time-series interpolation technique.

In some embodiments, the predicting of the missed location data may be further based on a gap filling technique.

In some embodiments, the predicting of the missed location data facilitates maintaining a continuity of the two or more locations.

In some embodiments, the pre-processing facilitates normalizing of the two or more location data.

In some embodiments, the one or more entities includes a mobile device.

In some embodiments, the one or more entities corresponds to a cellular network provider.

In some embodiments, the one or more entities corresponds to a wireless fidelity signal provider.

In some embodiments, the two or more location data may be based on one or more of a Global Positioning System and a wireless fidelity signal.

In some embodiments, the two or more location data includes one or more of two or more latitude coordinates and two or more longitude coordinates.

In some embodiments, the two or more location data represents the two or more locations with two or more time instances.

In some embodiments, the security criterion may be based on a location.

In some embodiments, the security criterion may be based on a variable associated with a location.

In some embodiments, the variable includes a time.

In some embodiments, the one or more entities may be associated with a movement. Further, the variable includes one or more of a speed and a velocity.

In some embodiments, the security criterion includes a predefined security rule.

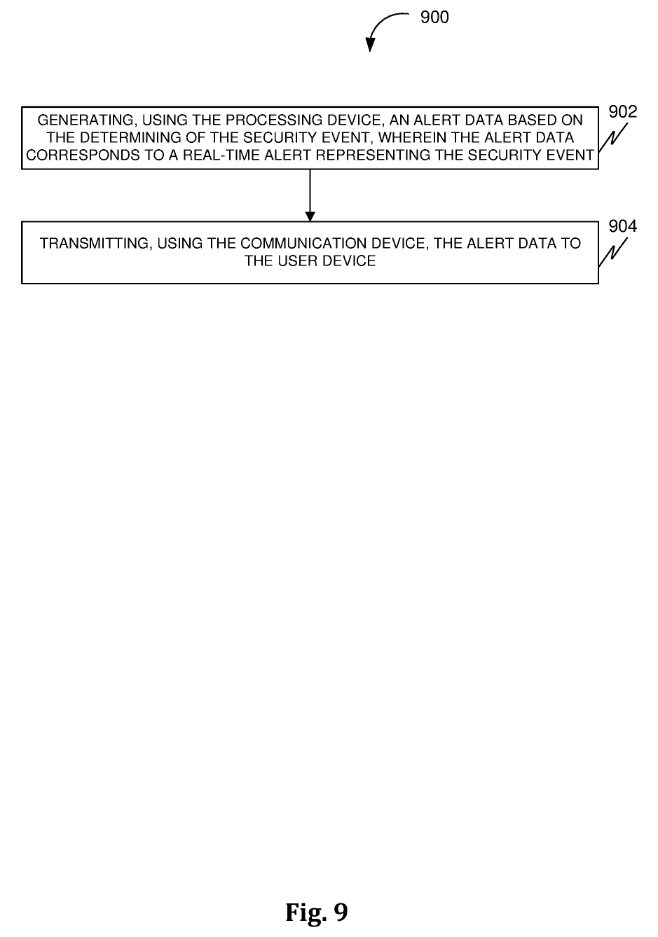

FIG. 9 illustrates a flowchart of a method 900 of facilitating a security monitoring including generating, using the processing device 704, an alert data, in accordance with some embodiments.

Further, in some embodiments, the method 900 further may include a step 902 of generating, using the processing device 704, an alert data based on the determining of the security event. Further, the alert data corresponds to a real-time alert representing the security event. Further, in some embodiments, the method 900 further may include a step 904 of transmitting, using the communication device 702, the alert data to the user device 804.

In some embodiments, the secured perimeter corresponds to a physical boundary which may be configured to protect a physical asset.

In some embodiments, the secured perimeter corresponds to one or more of a wall, a property line, and a fence. Further, the physical asset corresponds to one or more of a building, a vehicle, and a machinery.

In some embodiments, the event data represent a transition of the one or more entities across the secured perimeter.

In some embodiments, the entity may be moved from a one side of the secured perimeter to an another side.

In some embodiments, the transition includes two or more transitions associated with two or more movement characteristics. Further, the security criterion may be based a movement characteristic associated with one or more of the two or more transitions.

In some embodiments, the two or more locations may be associated with a location of the secured perimeter.

In some embodiments, the movement pattern may be based on a change in a variable representing the two or more locations.

In some embodiments, the variable includes one or more of a latitude, a longitude, a time instance, and a direction.

In some embodiments, the movement pattern may be further based on a distance between two or more locations.

In some embodiments, the two or more transitions include one or more of a climbing over the secured perimeter, a tunneling under the secured perimeter, and a breaching a barrier of the secured perimeter.

In some embodiments, the analyzing of the spatial data facilitates a real-time recalibration of the spatial data.

In some embodiments, the physical asset corresponds to a secured perimeter boundary.

In some embodiments, the spatial data includes at least one a geographical information system data and a drone image data.

In some embodiments, the spatial data may be generated based on a sensing of a variable associated with the physical asset. Further, the sensing may be based on a sensor device.

In some embodiments, the analyzing of the spatial data includes identifying a change in the spatial detail.

In some embodiments, the change may be based on one or more of a construction activity and a natural environmental change.

In some embodiments, the vector data includes a spatial temporal vector data.

In some embodiments, the two or more characteristics further includes a speed of the movement.

In some embodiments, the two or more locations may be represented based on a sequential location point.

In some embodiments, the determining includes analyzing consistency of one or more of the magnitude and the direction.

In some embodiments, the security criterion may be based on one or more of the magnitude and the direction.

In some embodiments, the determining includes detecting a change in the direction.

In some embodiments, the determining includes detecting an inconsistency of movement velocity with one or more of a pedestrian and a vehicle activity.

In some embodiments, the security criterion includes a context-based rule.

In some embodiments, the security event corresponds to a loitering behavior near a boundary of a secured perimeter. Further, the security criterion may be based on the secured perimeter.

In some embodiments, the AI model may be configured to differentiate an event movement from one or more of the two or more movements and a stationary location. Further, the two or more location data further represents the stationary location.

In some embodiments, the user may be intended to protect a physical asset from the security event.

In some embodiments, the user device 804 may be configured to present a visual representation of the security event on a security presentation device. Further, the event data includes the visual representation of the security event. Further, the security presentation device may be comprised in the user device 804.

In some embodiments, the event data represents the security event with a location. Further, the security event may be occurred at the location.

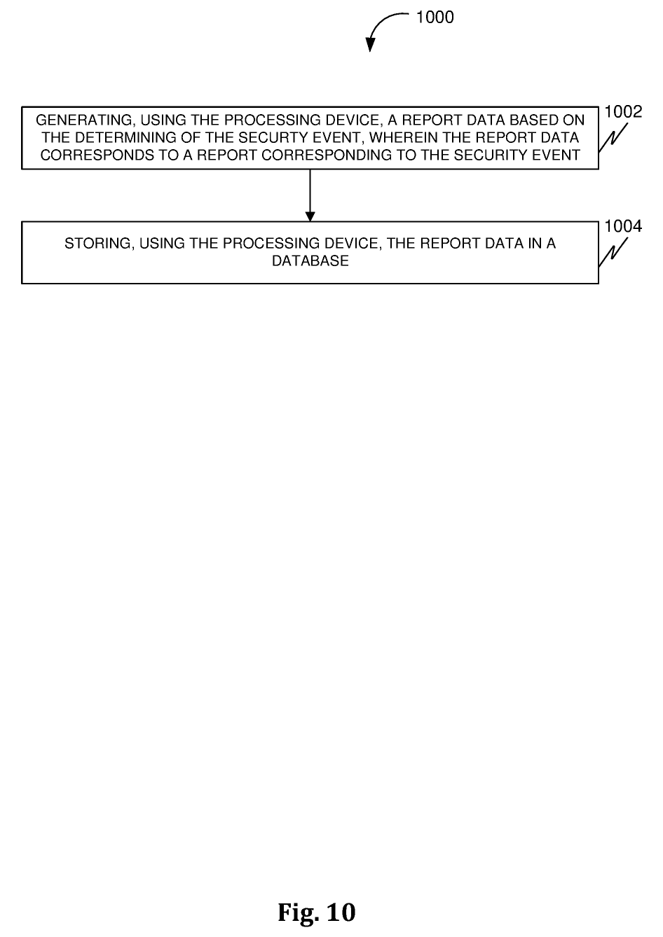

FIG. 10 illustrates a flowchart of a method 1000 of facilitating a security monitoring including generating, using the processing device 704, a report data, in accordance with some embodiments.

Further, in some embodiments, the method 1000 further may include a step 1002 of generating, using the processing device 704, a report data based on the determining of the security event. Further, the report data corresponds to a report corresponding to the security event. Further, in some embodiments, the method 1000 further may include a step 1004 of storing, using the processing device 704, the report data in a database.

In some embodiments, the report data may be utilized for a forensic review.

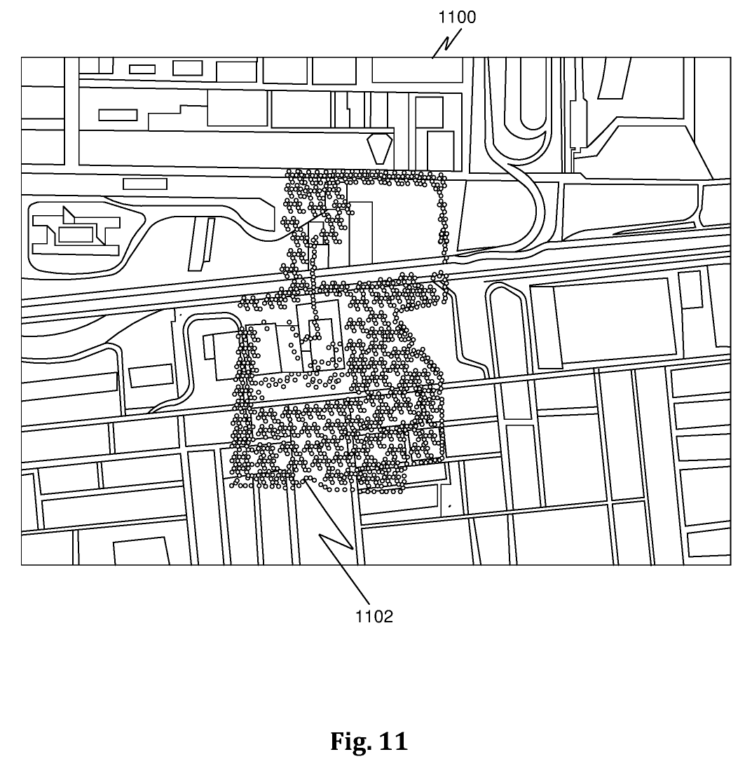

FIG. 11 illustrates two or more locations 1102 of one or more entities within a monitored area 1100, in accordance with some embodiments. Further, the two or more locations 1102 may be illustrated as two or more circles. Further, the security criterion is based on the monitored area 1100. Further, the one or more entities includes one or more mobile devices associated with one or more users.

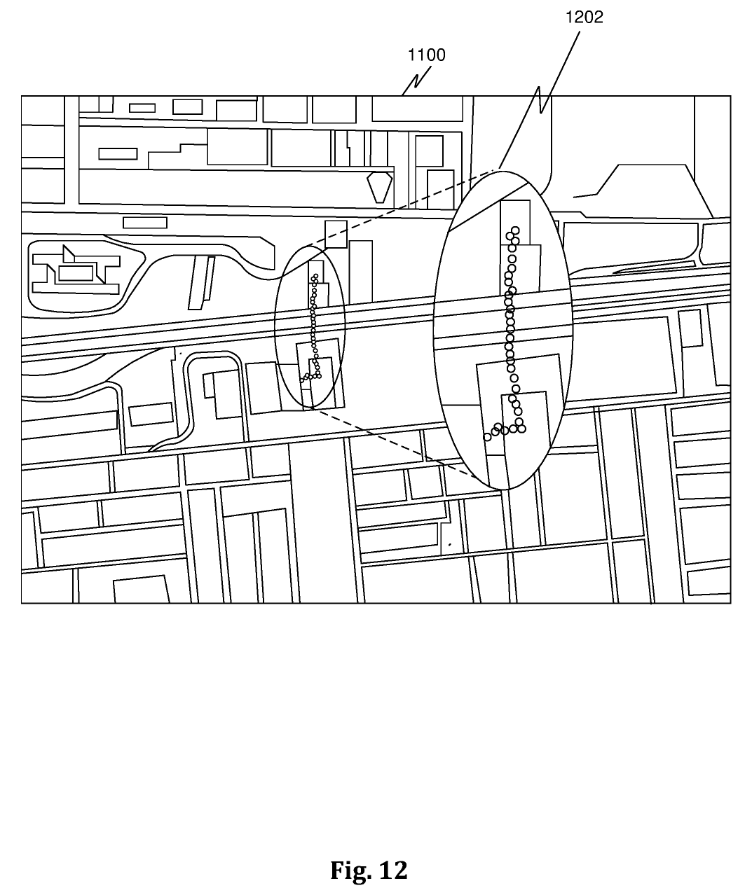

FIG. 12 illustrates a security event 1202 associated with the monitored area 1100, in accordance with some embodiments. Further, the security criterion is based on a secured perimeter associated with the monitored area 1100. Further, the security criterion corresponds to a movement in relation to the secured perimeter. Further, the security event 1202 depicts the movement of one or more entities across the secured perimeter.

Although the invention has been explained in relation to its preferred embodiment, it is to be understood that many other possible modifications and variations can be made without departing from the spirit and scope of the invention as hereinafter claimed.

What is claimed is:

1. A method of facilitating a security monitoring, the method comprising:
receiving, using a communication device, a plurality of location data from a client device, wherein the plurality of location data corresponds to a plurality of locations of at least one entity;
pre-processing, using a processing device, the plurality of location data to obtain a plurality of pre-processed location data, wherein the pre-processing reduces noise associated with the plurality of location data;
analyzing, using the processing device, the plurality of pre-processed location data based on a security criterion;
determining, using the processing device, a security event based on the analyzing;
generating, using the processing device, an event data based on the determining, wherein the event data represents the security event; and
transmitting, using the communication device, the event data to a user device associated with a user.

2. The method of claim 1, wherein the plurality of location data comprises each of a plurality of prior location data and an erratic location data representing a random change in at least one of the plurality of locations, wherein the pre-processing comprises:
generating a model data based on the plurality of prior location data, wherein the plurality of prior location data corresponds to a plurality of prior locations corresponding at a plurality of prior time instances, wherein the model data corresponds to a mathematical model representing a movement of the at least one entity;
predicting a second location data based on the model data, wherein the second location data corresponds to a second location occurring at a second time instance, wherein the second time instance occurs after the plurality of prior time instances; and
filtering the erratic location data based on the second location data.

3. The method of claim 1, wherein the noise corresponds to an outlier location, wherein the plurality of locations comprises an outlier location, wherein the pre-processing comprises:
generating a cluster data, wherein the cluster data corresponds to a clustered location comprising a plurality of clustered locations, wherein the generating of the cluster data is further based on a distance between the plurality of locations;
identifying an outlier data based on the cluster data, wherein the outlier data represents the outlier location, wherein the distance between the plurality of clustered locations comprises a first value, wherein the distance between the clustered location and the outlier location comprises a second value, wherein the second value is greater than the first value; and
filtering the outlier data from the plurality of location data based on the identifying.

4. The method of claim 1, wherein the pre-processing comprises predicting a missed location data based on the plurality of location data, wherein the missed location data corresponds to a missed location, wherein the predicting of the missed location data is based on an interpolating of a plurality of adjacent locations, wherein the plurality of adjacent locations is adjacent to the missed location, wherein the interpolating is based on an interpolation technique based on a plurality of time instances, wherein the plurality of location occurs at the plurality of time instances, wherein the plurality of location data represent the plurality of locations with the plurality of time instances, wherein the plurality of locations comprise the plurality of adjacent locations.

5. The method of claim 1, wherein the pre-processing comprises predicting a missed location data based on the plurality of location data, wherein the missed location data corresponds to a missed location, wherein the predicting of the missed location data is further based on a plurality of factors associated with the plurality of locations, wherein the plurality of factors corresponds to a pattern and a context associated with the plurality of locations.

6. The method of claim 1, wherein the determining of the security event comprises identifying a movement pattern of the at least one entity, wherein the movement pattern is associated with a movement characteristic, wherein at least one of the movement pattern and the movement characteristic indicates the security event.

7. The method of claim 1 further comprises:
receiving, using the processing device, a spatial data from the client device, wherein the spatial data represents a spatial detail associated with a physical asset, wherein the security criterion is based on the physical asset;
analyzing, using the processing device, the spatial data based on a predetermined spatial data, wherein the predetermined spatial data represents a predetermined spatial detail, wherein the receiving of the spatial data occurs at a second time instance, wherein a receiving of the predetermined spatial data occurs at a first time instance, wherein the second time instance occurs after the first time instance; and
generating, using the processing device, a representation data based on the analyzing of the spatial data, wherein the representation data corresponds to an updated representation of the physical asset, wherein the determining of the security event is further based on the representation data.

8. The method of claim 1 further comprises generating, using the processing device, a vector data based on the analyzing of the plurality of pre-processed location data, wherein the vector data represents a movement associated with the at least one entity based on a plurality of characteristics, wherein the plurality of characteristics corresponds to each of a magnitude and a direction of the movement, wherein the determining of the security event is further based on the vector data.

9. The method of claim 8, wherein the determining of the security event comprises differentiating an event movement from a normal movement based on the plurality of characteristics, wherein the event movement corresponds to an activity associated with the security event, wherein the vector data represents a plurality of movements comprising each of the event movement and the normal movement, wherein the plurality of locations corresponds to the plurality of movements.

10. The method of claim 1, wherein the security criterion is based on a secured perimeter, wherein the security event corresponds to an unauthorized breach of the secured perimeter.

11. A system for facilitating a security monitoring, the system comprising:
a communication device configured for:
receiving a plurality of location data from a client device, wherein the plurality of location data corresponds to a plurality of locations of at least one entity; and
transmitting an event data to a user device associated with a user; and
a processing device communicatively coupled with the communication device, wherein the processing device is configured for:
pre-processing the plurality of location data to obtain a plurality of pre-processed location data, wherein the pre-processing reduces noise associated with the plurality of location data;
analyzing the plurality of pre-processed location data based on a security criterion;
determining a security event based on the analyzing; and
generating the event data based on the determining, wherein the event data represents the security event.

12. The system of claim 11, wherein the plurality of location data comprises each of a plurality of prior location data and an erratic location data representing a random change in at least one of the plurality of locations, wherein the pre-processing comprises:
generating a model data based on the plurality of prior location data, wherein the plurality of prior location data corresponds to a plurality of prior locations corresponding at a plurality of prior time instances, wherein the model data corresponds to a mathematical model representing a movement of the at least one entity;
predicting a second location data based on the model data, wherein the second location data corresponds to a second location occurring at a second time instance, wherein the second time instance occurs after the plurality of prior time instances; and
filtering the erratic location data based on the second location data.

13. The system of claim 11, wherein the noise corresponds to an outlier location, wherein the plurality of locations comprises an outlier location, wherein the pre-processing comprises:
generating a cluster data, wherein the cluster data corresponds to a clustered location comprising a plurality of clustered locations, wherein the generating of the cluster data is further based on a distance between the plurality of locations;
identifying an outlier data based on the cluster data, wherein the outlier data represents the outlier location, wherein the distance between the plurality of clustered locations comprises a first value, wherein the distance between the clustered location and the outlier location comprises a second value, wherein the second value is greater than the first value; and
pre-processing further comprises filtering the outlier data from the plurality of location data based on the identifying.

14. The system of claim 11, wherein the pre-processing comprises predicting a missed location data based on the plurality of location data, wherein the missed location data corresponds to a missed location, wherein the predicting of the missed location data is based on an interpolating of a plurality of adjacent locations, wherein the plurality of adjacent locations is adjacent to the missed location, wherein the interpolating is based on an interpolation technique based on a plurality of time instances, wherein the plurality of location occurs at the plurality of time instances, wherein the plurality of location data represent the plurality of locations with the plurality of time instances, wherein the plurality of locations comprise the plurality of adjacent locations.

15. The system of claim 11, wherein the pre-processing comprises predicting a missed location data based on the plurality of location data, wherein the missed location data corresponds to a missed location, wherein the predicting of the missed location data is further based on a plurality of factors associated with the plurality of locations, wherein the plurality of factors corresponds to a pattern and a context associated with the plurality of locations.

16. The system of claim 11, wherein the determining of the security event comprises identifying a movement pattern of the at least one entity, wherein the movement pattern is associated with a movement characteristic, wherein at least one of the movement pattern and the movement characteristic indicates the security event.

17. The system of claim 11, wherein the processing device is further configured for:
receiving a spatial data from the client device, wherein the spatial data represents a spatial detail associated with a physical asset, wherein the security criterion is based on the physical asset;
analyzing the spatial data based on a predetermined spatial data, wherein the predetermined spatial data represents a predetermined spatial detail, wherein the receiving of the spatial data occurs at a second time instance, wherein a receiving of the predetermined spatial data occurs at a first time instance, wherein the second time instance occurs after the first time instance; and
generating a representation data based on the analyzing of the spatial data, wherein the representation data corresponds to an updated representation of the physical asset, wherein the determining of the security event is further based on the representation data.

18. The system of claim 11, wherein the processing device is further configured for generating a vector data based on the analyzing of the plurality of pre-processed location data, wherein the vector data represents a movement associated with the at least one entity based on a plurality of characteristics, wherein the plurality of characteristics corresponds to each of a magnitude and a direction of the movement, wherein the determining of the security event is further based on the vector data.

19. The system of claim 18, wherein the determining of the security event comprises differentiating an event movement from a normal movement based on the plurality of characteristics, wherein the event movement corresponds to an activity associated with the security event, wherein the vector data represents a plurality of movements comprising each of the event movement and the normal movement, wherein the plurality of locations corresponds to the plurality of movements.

20. The system of claim 11, wherein the security criterion is based on a secured perimeter, wherein the security event corresponds to an unauthorized breach of the secured perimeter.
